(19) United States
(12) Patent Application Publication
(10) Pub. No.: US 2019/0359037 A1
(43) Pub. Date: Nov. 28, 2019

(54) SHADING DEVICE FOR A VEHICLE WINDOW

(71) Applicant: Goran BILANDZIJA, Reichenbach (DE)

(72) Inventor: Goran BILANDZIJA, Reichenbach (DE)

(21) Appl. No.: 16/303,359

(22) PCT Filed: Mar. 23, 2017
(86) PCT No.: PCT/EP2017/056987

§ 371 Date: Nov. 20, 2018

(30) Foreign Application Priority Data
May 23, 2016 (DE) 10 2016 208 896.3

(51) Int. Cl. B60J 3/02; B60J 1/20

(52) U.S. Cl. CPC B60J 3/02; E06B 9/42; B60J 1/2086; B60J 1/2063

(57) ABSTRACT

A shading device having a housing structure with an accommodating space intended for a winding shaft and a through-passage and having a flap mounted in a pivotable manner on the housing structure and intended for closing and releasing the through-passage. A windable shading structure is retained on the winding and has a pull-out profile on a front end region, and a supporting rod acts on the pull-out profile. A drive system guides the pull-out profile between a rest position, in which the profile is positioned in the accommodating space and a functional position, in which the profile is displaced upward along the vehicle window. The supporting rod can be displaced vertically through the through-passage of the accommodating space. In the region of its underside, the flap has a sliding or rolling element, against which the supporting rod butts when the flap is open.

The invention relates to a shading device for a vehicle window, having a housing structure, which has an accommodating space which is intended for a winding shaft and has a through-passage in the direction of an upper side, and having a flap, which is mounted in a pivotable manner on the housing structure and is intended for closing and releasing the through-passage, and having a flexible shading structure, which is retained on the winding shaft such that it can be wound up and unwound and which has a dimensionally stable pull-out profile provided on its front end region, as seen in the unwinding direction, and having a supporting rod, which acts on the pull-out profile, and, by means of a drive system, guides the pull-out profile between a rest position, in which said profile is positioned in the accommodating space, and a functional position, in which said profile has been displaced upward along the vehicle window, wherein the supporting rod can be displaced vertically through the through-passage of the accommodating space.

Such a shading device is generally known in Mercedes-Benz S-Class passenger vehicles. The known shading device has a flexible shading structure in the form of a knitted fabric, which is retained on a winding shaft such that it can be wound up and unwound. The winding shaft is mounted in a rotatable manner on the inside of the door, beneath an inner door sill of the side door. The winding shaft is accommodated in a housing structure, which is arranged on the inside of the door, beneath an inner door sill of the side door. The housing structure is open in the upward direction in the region of a through-passage, in order to allow the shading structure to be guided through from a rest position into a shading position, in which the shading structure screens the side window of the side door. In the rest position of the shading structure, in which the shading structure has been wound up onto the winding shaft, the through-passage is closed by a pivotable flap, which in its closed position terminates flush with the inner door sill. The shading structure has a dimensionally stable pull-out profile on its front end region, as seen in the pull-out direction, said pull-out profile being carried by a centrally acting supporting rod. The supporting rod is part of a drive system for displacing the pull-out profile and thus for displacing the shading structure between the rest position and the shading position. The supporting rod can be displaced vertically and is driven in both directions, i.e. both upward and downward, by an electric motor in conjunction with suitable drive-transmission means. When the supporting rod is displaced from the rest position in the direction of the shading position, the supporting rod pushes the pull-out profile upward, as a result of which the pull-out profile strikes against the flap and pivots the flap open in the upward direction. The supporting rod is positioned on that side of the shading structure which is directed toward the flap, and therefore, as it travels vertically in the direction of the shading position, the supporting rod slides permanently along the flap, which, on account of being spring-prestressed in the closing direction, butts permanently against the supporting rod. This can give rise to signs of wear on the flap, which can detract from the visual appearance of the flap in the region of the inner door sill.

It is the object of the invention to create a shading device of the type mentioned in the introduction which provides for an improved impression of quality.

This object is achieved in that, in the region of its underside, the flap has a sliding or rolling element, against which the supporting rod butts when the flap is open. The solution according to the invention avoids the situation where the flap butts directly against the supporting rod by way of a peripheral region which is visible even in the closed state. Rather, the flap is supported on the supporting rod via the sliding or rolling element, which is arranged in the region of the underside of the flap. In the closed state of the flap, said sliding or rolling element is not visible, and therefore the visual appearance, and consequently the impression of quality, of an interior trim in the region of the vehicle window is not impaired by any signs of wear. The solution according to the invention is particularly advantageously suitable for use in the region of a vehicle window of a side door of a passenger vehicle, preferably of a rear side door. A sliding element can be formed in one piece on the inner side or the underside of the flap. As an alternative, it is possible for a corresponding sliding element to be produced as a separate component and then to be fastened in the region of the inner side or underside of the flap. The rolling element provided is preferably a roller or a wheel, these being mounted in a rotatable manner in the region of the underside of the flap. The roller or the wheel is preferably of at least essentially cylindrical design. As an alternative, it is possible for the roller or the wheel to be provided with a concave or convex rotary cross section. The winding shaft can in particular be of cylindrical or conical design.

In one configuration of the invention—as seen in the longitudinal direction of the flap—the sliding or rolling element has a width which is greater than a width of the supporting rod. This configuration is advantageous in order to provide for reliable abutment and support of the sliding or rolling element of the flap against or on the supporting rod over an entire movement path of the supporting rod. Since the supporting rod projects freely upward from the through-passage of the housing structure, and a pull-out direction of the shading structure, on the one hand, and a movement direction of the supporting rod, on the other hand, can differ slightly from one another, it is possible for the supporting rod to perform additional transverse movements relative to the flap. Since the sliding or rolling element has a width which is greater than the width of the supporting rod, it is possible for corresponding transverse movements of the supporting rod to be compensated for without the abutment or support of the sliding or rolling element relative to the supporting rod being eliminated. As an alternative, it is possible for the rolling element to be mounted in a rotatable manner on a rotary spindle which has a length greater than the width of the rolling element. This means that, in addition to its rotary movement capability, the rolling element can also be displaced along the rotary spindle, as a result of which it is possible to adjust the rolling element relative to transverse movements of the supporting rod.

In a further configuration of the invention, the width of the sliding or rolling element is two times to ten times greater than the width of the supporting rod. This range has proven to be advantageous in order to compensate for transverse movements of the supporting rod. This width range is advantageously combined with a conical winding shaft, as a result of which the shading structure can be displaced at an angle to the direction in which the supporting rod is guided.

In a further configuration of the invention, a rotary spindle of the rolling element is oriented at least largely parallel to a pivot axis of the flap. This makes it possible to achieve just a low level of friction when the supporting rod butts against the rolling element. The rotary spindle of the rolling element can deviate from parallel orientation relative to the pivot axis of the flap by preferably between 0.1 and 1%, advantageously 0.5%.

In a further configuration of the invention, the flap is permanently forced, on a torque-assisted basis, in the direction of its closed position by a mechanical spring device. The spring device has preferably one or more leg springs, which are active between the housing structure and the flap, coaxially to a pivot axis of the flap. If a plurality of leg springs are provided, these are arranged distributed over the length of the flap.

Further advantages and features of the invention can be gathered from the claims and from the following description of a preferred exemplary embodiment of the invention, said exemplary embodiment being illustrated with reference to the drawings, in which:

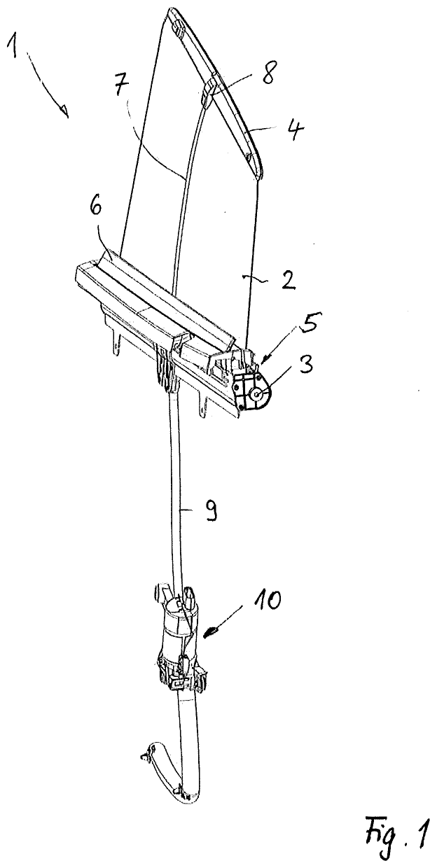

FIG. 1 shows a perspective illustration of an embodiment of a shading device according to the invention for shading a vehicle window of a side door of a passenger vehicle,

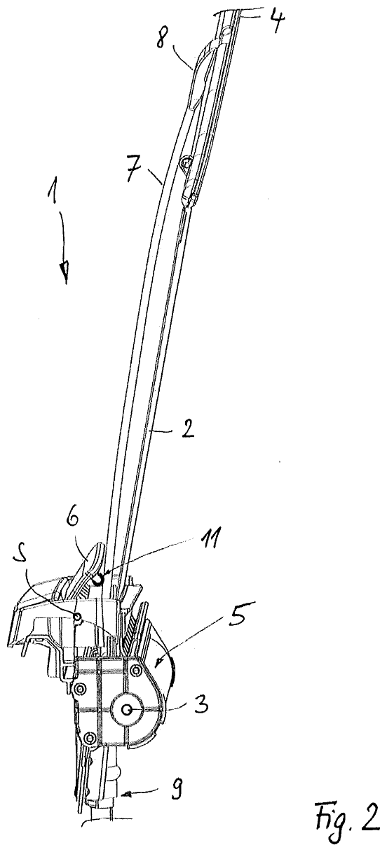

FIG. 2 shows an enlarged side view of the shading device according to FIG. 1,

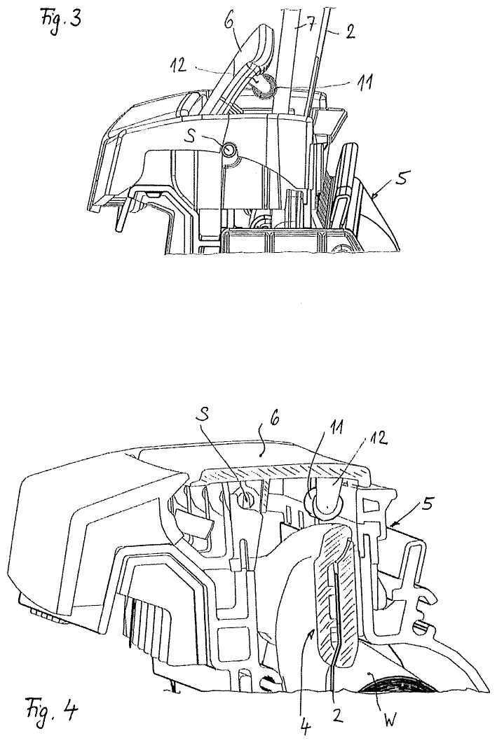

FIG. 3 shows a further-enlarged illustration of part of the shading device according to FIG. 2,

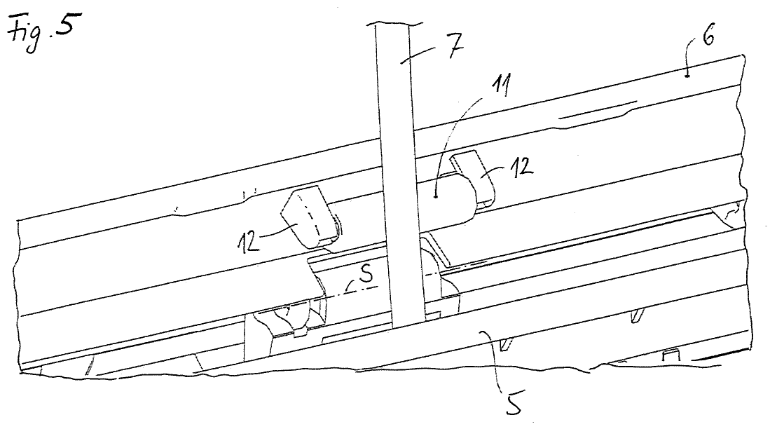

FIG. 4 shows an enlarged sectional illustration of part of the shading device according to FIGS. 1 to 3 in a rest position of a pull-out profile of the shading structure, and\

FIG. 5 shows a schematic, perspective illustration of part of the shading device according to FIGS. 1 to 4 in the region where a flap of the shading device is supported on a supporting rod of the shading device.

A shading device 1 according to FIGS. 1 to 5 is arranged in the ready-to-operate state in the region of an inner side of a side door of a passenger vehicle and serves for shading a vehicle window of said side door. The shading device 1 has a flexible shading structure 2, which is designed in the form of a knitted fabric and is retained on a winding shaft W (FIG. 4) such that it can be wound up and unwound. The winding shaft W is mounted in a cassette-like housing structure 5 such that it can be rotated about a rotary spindle 3. The housing structure 5 is fastened in the ready-to-operate state on body-structure portions of the inner side of the side door, beneath an inner door sill. The inner door sill delimits an underside of the vehicle window. The housing structure 5 forms an accommodating space for the winding shaft W, said accommodating space being open in the direction of an upper side in the region of a through-passage. The through-passage can be closed by a flap 6, which in its closed position (FIG. 4) is aligned flush with an upper side of the housing structure 5 and flush with the inner door sill. The flap 6 is mounted in a pivotable manner about a pivot axis S, which extends parallel to the rotary spindle 3 of the winding shaft W. The flap 6 can be pivoted between the closed position according to FIG. 4 and an open position according to FIGS. 1 to 3 and 5. The flap 6 is permanently forced in the direction of its closed position by a mechanical spring device (not indicated any more specifically), and therefore, in the closed position according to FIG. 4, the flap 6 rests in an unloaded state on a periphery of the through-passage of the housing structure 5. The mechanical spring device comprises a plurality of leg springs, which are arranged distributed over the length of the flap 6 and are positioned coaxially to the pivot axis.

The shading structure 2 can be displaced vertically between a rest position (FIG. 4) and a shading position (FIGS. 1 and 2). For displacement of the shading structure 2, the shading structure 2 has a dimensionally stable pull-out profile 4 on its front end region, as seen in the pull-out direction, said pull-out profile being curved in accordance with an upper frame region of the vehicle window. The pull-out profile 4 can be displaced vertically by means of a supporting rod 7 between the rest position and the shading position of the shading structure 2. The supporting rod 7 is part of a drive system. The supporting rod 7 is of flexurally rigid design and is guided in a vertically linear manner in a linear guide 9 with the aid of a drive-transmission means, preferably with the aid of a thread-pitch cable. The drive-transmission means is driven by an electric motor 10 and a suitable gear mechanism, these forming part of the drive system. The thread-pitch cable is laid in the linear guide 9 and has its end connected to the supporting rod 7. Even in the shading position of the shading structure 2, the supporting rod 7 remains with a lower part in the linear guide 9.

In the region of the pull-out profile 4, the supporting rod 7 has its end acting on the pull-out profile 4 via a holder 8, and therefore the supporting rod 7 remains permanently connected to the pull-out profile 4 in the region of the holder 8 during displacement movements in all directions.

It can be seen with reference to FIG. 2 that an outer contour of the holder 8 is curved convexly such that, during an outward-travel movement or during an inward-travel movement of the supporting rod 7 and of the pull-out profile 4, the rolling element 11 can be permanently supported on the corresponding outer side of the pull-out profile 4, of the holder 8 and of the supporting rod 7 without this resulting in a shoulder, a step or an undercut, which could cause jamming between the rolling element 11 and the supporting rod 7, the holder 8 or the pull-out profile 4. This ensures that, throughout an inward-travel or outward-travel operation of the pull-out profile 8 and of the supporting rod 7, the flap 6 is supported only in the region of the rolling element 11 in the region of the underside of the flap 6, and therefore, in the case of multiple inward-travel and outward-travel operations, signs of wear can occur at most on the rolling element 11, but not on a peripheral region of the flap 6. The rolling element 11 can be retained in an interchangeable manner between bearing blocks 12.

When the supporting rod 7 pushes the pull-out profile 4 upward from the rest position (FIG. 4), the pull-out profile 4 pushes against the flap 6 from an underside and pushes the flap 6 open. It can be seen with reference to FIGS. 1 to 3 that the supporting rod 7 is positioned on that side of the shading structure 2 which is directed toward the open flap 6. The supporting rod 7 extends upward through the accommodating space of the housing structure 5 and through the through-passage, and therefore, when the pull-out profile 4 is displaced vertically upward or downward, the flap 6 is supported on an outer side of the supporting rod 7, said outer side being directed away from the shading structure 2. Here, the flap 6 is not supported directly, but with the aid of a rolling element 11, on the outer side of the supporting rod 7 directed away from the shading structure 2. The rolling element 11 is mounted in the region of an underside of the flap 6 such that it can be rotated about a rotary spindle which extends parallel to the pivot axis S of the flap 6. The rolling element 11 is mounted by two bearing blocks 12, which are integrally formed on the underside of the flap 6 and carry the rotary spindle for the rolling element 11. The rolling element 11 is designed in the form of a cylindrical roller of which—as seen in the direction of its rotary spindle —the length is significantly greater than a width of the supporting rod 7 (FIG. 5). The rolling element 11 projects from the underside of the flap 6 in the direction of the supporting rod 7 such that, in the open position, the flap 6 is supported on the outer side of the supporting rod 7 exclusively via the rolling element 11 (see FIGS. 2 and 3).

The winding shaft W is of conical design, and therefore, when the pull-out profile 4 is displaced upward or downward, the supporting rod 7, in addition to being displaced vertically, is also displaced in the transverse direction.

In order to ensure that the flap 6 remains supported on the outer side of the supporting rod 7 via the rolling element 11 even during transverse-displacement movements of the supporting rod 7, while the supporting rod 7 is correspondingly traveling in or out, the abovedescribed, significantly greater length of the rolling element 11 relative to the width of the supporting rod 7 is provided. In the case of the exemplary embodiment illustrated according to FIG. 5, the rolling element 11 has a length which is approximately three times to four times greater than the width of the supporting rod 7 extended in the same direction. The supporting rod 7 is designed in the form of a round rod and consists of a spring steel. As an alternative, the supporting rod can be provided with a square profile. It is also possible for the supporting rod 7 to be designed in the form of a plastic part.

1. A shading device for a vehicle window, having a housing structure, which has an accommodating space which is intended for a winding shaft and has a through-passage in the direction of an upper side, and having a flap, which is mounted in a pivotable manner on the housing structure and is intended for closing and releasing the through-passage, and having a flexible shading structure, which is retained on the winding shaft such that it can be wound up and unwound and which has a dimensionally stable pull-out profile provided on its front end region, as seen in the unwinding direction, and having a supporting rod, which acts on the pull-out profile, and, by means of a drive system, guides the pull-out profile between a rest position, in which said profile is positioned in the accommodating space, and a functional position, in which said profile has been displaced upward along the vehicle window, wherein the supporting rod can be displaced vertically through the through-passage of the accommodating space, wherein, in the region of its underside, the flap has a sliding or rolling element, against which the supporting rod butts when the flap is open.

2. The shading device as claimed in claim 1, wherein the winding shaft is of conical design.

3. The shading device as claimed in claim 1, wherein—as seen in the longitudinal direction of the flap—the sliding or rolling element has a width which is greater than a width of the supporting rod.

4. The shading device as claimed in claim 3, wherein the width of the sliding or rolling element is two times to ten times greater than the width of the supporting rod.

5. The shading device as claimed in claim 1, wherein a rotary spindle of the rolling element is oriented at least largely parallel to a pivot axis of the flap.

6. The shading device as claimed in claim 1, wherein the flap is permanently forced, on a torque-assisted basis, in the direction of its closed position by a mechanical spring device.
